(19) United States
(12) Patent Application Publication
(10) Pub. No.: US 2024/0316523 A1
(43) Pub. Date: Sep. 26, 2024

(54) PROCESS OF MAKING A SALTED SPRAY-DRIED PERFUME MICROCAPSULE PARTICLE

(71) Applicant: The Procter & Gamble Company, Cincinnati, OH (US)

(72) Inventor: Patricia ANDREU, Newcastle upon Tyne (GB)

(21) Appl. No.: 18/609,358

(22) Filed: Mar. 19, 2024

(30) Foreign Application Priority Data
Mar. 24, 2023 (EP) 23164188.7

(51) Int. Cl. B01J 13/04; C11B 9/00

(52) U.S. Cl. CPC B01J 13/043; C11B 9/00

(57) ABSTRACT

The present invention relates to a process of making a salted spray-dried perfume microcapsule particle.

### FIELD OF THE INVENTION

The present invention relates to a process of making a salted spray-dried perfume microcapsule particle.

### BACKGROUND OF THE INVENTION

Laundry treatment applications, such as laundry and fabric enhancing, as well as many other treatment applications, seek to provide freshness benefits to the treated surfaces. A common method of providing freshness benefits is to use a perfume microcapsule.

Perfume oil is often flammable, sometimes highly flammable, and the method of making the perfume microcapsule, as well as the method of transporting the perfume microcapsule needs to be carefully controlled to mitigate any flammable risks, including explosion risks.

The inventors have discovered that the addition of sodium chloride into an aqueous perfume microcapsule mixture that is subsequently spray-dried provides a salted spray-dried perfume microcapsule particle that has low flammable risk, including low risk of explosion, even during storage and transport.

### SUMMARY OF THE INVENTION

The present invention provides a process of making a salted spray-dried perfume microcapsule particle, wherein the process comprises the steps:
(a) preparing an aqueous perfume microcapsule mixture comprising from 20 wt % to 70 wt % perfume microcapsules;
(b) contacting sodium chloride to the aqueous perfume microcapsule mixture to form a salted aqueous perfume microcapsule mixture comprising from 2.0 wt % to 10 wt % said sodium chloride; and
(c) spray-drying the salted aqueous perfume microcapsule mixture to form a salted spray-dried perfume microcapsule particle, wherein the salted spray-dried perfume microcapsule particle comprises from 4.0 wt % to 20 wt % said sodium chloride.

### DETAILED DESCRIPTION OF THE INVENTION

Process of Making a Salted Spray-Dried Perfume Microcapsule Particle.

The process comprises the steps:
(a) preparing an aqueous perfume microcapsule mixture comprising from 20 wt % to 70 wt % perfume microcapsules;
(b) contacting sodium chloride to the aqueous perfume microcapsule mixture to form a salted aqueous perfume microcapsule mixture comprising from 2.0 wt % to 10 wt % said sodium chloride; and
(c) spray-drying the salted aqueous perfume microcapsule mixture to form a salted spray-dried perfume microcapsule particle, wherein the salted spray-dried perfume microcapsule particle comprises from 4.0 wt % to 20 wt % said sodium chloride.

### Step (a), Preparing an Aqueous Perfume Microcapsule Mixture

Step (a) prepares an aqueous perfume microcapsule mixture comprising from 20 wt % to 70 wt % perfume microcapsules.

The aqueous perfume microcapsule mixture can be prepared by combining a perfume with a shell material in water to form an emulsion, and then encapsulating the perfume with the shell material to form an aqueous perfume microcapsule mixture.

Other ingredients may be present, for example an initiator, and a partitioning modifier, pH adjuster, an emulsifier, a deposition aid, a structurant, and any combination thereof.

The encapsulation of the perfume can occur by heating the emulsion in one or more heating steps to form a shell encapsulating the perfume core, thereby forming perfume microcapsules that are typically dispersed in an aqueous continuous phase.

Step (a) can be carried out in any suitable equipment, including continuous stirred tank reactors, homogenizers, turbine agitators, recirculating pumps, paddle mixers, plough shear mixers, ribbon blenders, vertical axis granulators and drum mixers, both in batch and, where available, in continuous process configurations, and extruders.

### Step (b), Forming a Salted Aqueous Perfume Microcapsule Mixture.

Step (b) contacts sodium chloride to the aqueous perfume microcapsule mixture to form a salted aqueous perfume microcapsule mixture comprising from 2.0 wt % to 10 wt % said sodium chloride.

Step (b) is preferably carried out in a mixer.

Step (b) may be carried out in a mixer having a tip speed of from 3.0 ms⁻¹ to 20 ms⁻¹.

Step (b) may be carried out in a mixer having a powder to volume ratio of from 20 kWm⁻³ to 20 kWm⁻³.

Step (b) is carried out in a mixer, wherein said sodium chloride and said aqueous perfume microcapsule mixture are mixed together for at least five minutes, or from 5.0 minutes to 20 minutes, to form said salted aqueous perfume microcapsule mixture.

Other ingredients may be present, for example a deposition aid.

### Step (c), Spray-Drying the Salted Aqueous Perfume Microcapsule Mixture

Step (c) spray-dries the salted aqueous perfume microcapsule mixture to form a salted spray-dried perfume microcapsule particle, wherein the salted spray-dried perfume microcapsule particle comprises from 4.0 wt % to 20 wt % said sodium chloride.

Step (c) is typically carried out in a spray-drying tower.

Step (c) can be carried out in a spray-drying tower having an air inlet temperature of from 140° C. to 220° C., or from 160° C. to 210° C. or from 180° C. to 200° C.

Step (c) can be carried out in a spray-drying tower, and wherein said salted aqueous perfume microcapsule mixture is sprayed into said spray-drying tower by a means selected from:
(a) a spinning wheel nozzle being operated at a rotation of at least 10,000 rpm; and/or
(b) a high-pressure nozzle being operated at an atomizer pressure of at least 3.5×10⁶ Pa.

### Aqueous Perfume Microcapsule Mixture.

The aqueous perfume microcapsule mixture comprises from 20 wt % to 70 wt % perfume microcapsules, preferably from 30 wt % to 60 wt % perfume microcapsules, or from 40 wt % to 50 wt % perfume microcapsules.

The aqueous perfume microcapsule mixture may comprise from 30 wt % to 80 wt %, or from 40 wt % to 70 wt %, or from 50 wt % to 60 wt % water.

The aqueous perfume microcapsule mixture may comprise other ingredients, for example an initiator, and a partitioning modifier, pH adjuster, an emulsifier, a deposition aid, and any combination thereof.

### Salted Aqueous Perfume Microcapsule Mixture.

The salted aqueous perfume microcapsule mixture comprises from 2.0 wt % to 10 wt % said sodium chloride.

Preferably, the salted aqueous perfume microcapsule mixture comprises from 2.0 wt % to 8.0 wt %, or from 2.0 wt % to 6.0 wt %, or from 2.0 wt % to 5.0 wt % said sodium chloride.

The salted aqueous perfume microcapsule mixture may comprise a deposition aid.

### Perfume Microcapsules.

The perfume microcapsule typically comprises a shell material that encapsulates a perfume core of perfume raw materials.

### Salted Spray-Dried Perfume Microcapsule Particle.

The salted perfume microcapsule typically comprises a shell material that encapsulates a perfume core of perfume raw materials.

The salted spray-dried perfume microcapsule particle, wherein the salted spray-dried perfume microcapsule particle comprises from 4.0 wt % to 20 wt % said sodium chloride, or from 5.0 wt % to 20 wt %, or from 5.0 wt % to 15 wt %, or from 5.0 wt % to 10 wt % said sodium chloride.

The salted spray-dried perfume microcapsule particle may have a particle size distribution such that the D₅₀ particle size is in the range of from 150 μm to 300 μm. The salted spray-dried perfume microcapsule particle may have a particle size distribution such that the D₁₀ particle size is in the range of from 10 μm to less than 90 μm. The salted spray-dried perfume microcapsule particle may have a particle size distribution such that the D₉₀ particle size is in the range of from greater than 300 μm to less than 500 μm. The particle size is typically determined by laser diffraction.

The salted spray-dried perfume microcapsule particle may have a bulk density in the range of from 300 g/l to 400g·l. The bulk density is typically measured by a cup density method. A suitable method is as follows: A 0.5 L cup is filled with the powder using a funnel to enable free flowing of the powder. A spatula is used to remove excess powder exceeding the dimensions of the cup. The weight of powder in the cup is measured (in grams) using a balance and divided by the 0.5 L to calculate the density (in g/L).

### Sodium Chloride.

The sodium chloride typically has a solubility saturation point at 20° C. in deionized water of greater than 10 g/100 ml, preferably greater than 15 g/100 ml, or greater than 20 g/100 ml, or greater than 25g/100 ml, or greater than 30g/100 ml.

### Perfume Raw Materials.

Any perfume raw material, or combinations thereof, can be used as core material(s) for the perfume microcapsule. Particularly suitable perfume raw materials are disclosed below.

| Item | Common Name | IUPAC Name |
|---|---|---|
| 1 | Methyl 2-methyl butyrate | methyl 2-methylbutanoate |
| 2 | Isopropyl 2-methyl butyrate | propan-2-yl 2-methylbutanoate |
| 3 | Ethyl-2 Methyl Butyrate | ethyl 2-methylbutanoate |
| 4 | Ethyl-2 Methyl Pentanoate | ethyl 2-methylpentanoate |
| 5 | Ethyl heptanoate | ethyl heptanoate |
| 6 | Ethyl octanoate | Ethyl octanoate |
| 7 | isobutyl hexanoate | 2-methylpropyl hexanoate |
| 8 | Amyl butyrate | pentyl butanoate |
| 9 | Amyl heptanoate | Pentyl heptanoate |
| 10 | Isoamyl isobutyrate | 3-methylbutyl 2-methylpropanoate |
| 11 | Hexyl acetate | hexyl acetate |
| 12 | hexyl butyrate | hexyl butanoate |
| 13 | hexyl isobutyrate | hexyl 2-methylpropanoate |
| 14 | hexyl isovalerate | hexyl 3-methylbutanoate |
| 15 | hexyl propionate | hexyl propanoate |
| 16 | Ethyl 2-cyclohexyl propanoate | ethyl 2-cyclohexylpropanoate |
| 17 | Ethyl 3,5,5-trimethyl hexanoate | ethyl 3,5,5-trimethylhexanoate |
| 18 | glyceryl 5-hydroxydecanoate | 2,3-dihydroxypropyl 5-hydroxydecanoate |
| 19 | Prenyl acetate | 3-methyl 2-butenyl acetate |
| 20 | 3-methyl 2-butenyl acetate | 3-methyl 2-butenyl acetate |
| 21 | methyl 3-nonenoate | methyl non-3-enoate |
| 22 | Ethyl (E)-dec-4-enoate | Ethyl (E)-dec-4-enoate |
| 23 | Ethyl (E)-oct-2-enoate | Ethyl (E)-oct-2-enoate |
| 24 | Ethyl 2,4-decadienoate | ethyl (2E,4Z)-deca-2,4-dienoate |
| 25 | Ethyl 3-octenoate | ethyl (E)-oct-3-enoate |
| 26 | Citronellyl acetate | 3,7-dimethyloct-6-enyl acetate |
| 27 | Ethyl trans-2-decenoate | ethyl (E)-dec-2-enoate |
| 28 | 2-hexen-1-yl isovalerate | [(E)-hex-2-enyl] acetate |
| 29 | 2-hexen-1-yl propionate | [(E)-hex-2-enyl] propanoate |
| 30 | 2-hexen-1-yl valerate | [(E)-hex-2-enyl] pentanoate |
| 31 | 3-hexen-1-yl (E)-2-hexenoate | [(Z)-hex-3-enyl] (E)-hex-2-enoate |
| 32 | 3-Hexen-1-yl 2-methyl butyrate | [(Z)-hex-3-enyl] 2-methylbutanoate |
| 33 | 3-hexen-1-yl acetate | [(Z)-hex-3-enyl] acetate |
| 34 | 3-hexen-1-yl benzoate | [(Z)-hex-3-enyl] benzoate |
| 35 | 3-hexen-1-yl formate | [(Z)-hex-3-enyl] formate |
| 36 | 3-hexen-1-yl tiglate | [(Z)-hex-3-enyl] (Z)-2-methylbut-2- |
| | | enoate |
| 37 | 2-methyl butyl 2-methyl butyrate | 2-methylbutyl 2-methylbutanoate |
| 38 | Butyl isovalerate | butyl 3-methylbutanoate |
| 39 | Geranyl acetate | [(2E)-3,7-dimethylocta-2,6-dienyl] acetate |
| 40 | Geranyl butyrate | [(2E)-3,7-dimethylocta-2,6-dienyl] |
| | | butanoate |
| 41 | Geranyl isovalerate | [(3E)-3,7-dimethylocta-3,6-dienyl] 3- |
| | | methylbutanoate |
| 42 | Geranyl propionate | [(2E)-3,7-dimethylocta-2,6-dieny1] |
| | | propanoate |
| 43 | Allyl cyclohexane acetate | prop-2-enyl 2-cyclohexylacetate |
| 44 | Allyl Cyclohexyl Propionate | prop-2-enyl 3-cyclohexylpropanoate |
| 45 | allyl cyclohexyl valerate | prop-2-enyl 5-cyclohexylpentanoate |
| 46 | benzyl octanoate | benzyl octanoate |
| 47 | cocolactone | 6-penty1-5,6-dihydropyran-2-one |
| 48 | coconut decanone | 8-methyl-1-oxaspiro(4.5)decan-2-one |
| 49 | gamma undecalactone | 5-heptyloxolan-2-one |
| 50 | gamma-decalactone | 5-hexyloxolan-2-one |
| 51 | gamma-dodecalactone | 5-octyloxolan-2-one |
| 52 | jasmin lactone | 6-[(E)-pent-2-enyl]oxan-2-one |
| 53 | Jasmolactone | 5-[(Z)-hex-3-enyl]oxolan-2-one |
| 54 | Nonalactone | 6-butyloxan-2-one |
| 55 | 6-acetoxydihydrotheaspirane | [2a,5a(S*)]-2,6,10,10-tetramethyl-1- |
| | | oxaspiro[4.5]decan-6-yl acetate |
| 56 | Phenoxyethyl isobutyrate | 2-(phenoxy)ethyl 2-methylpropanoate |
| 57 | Pivacyclene | |
| 58 | Verdox | (2-tert-butylcyclohexyl) acetate |
| 59 | cyclobutanate | 3a,4,5,6,7,7a-hexahydro-4,7-methano-1g- |
| | | inden-5(or 6)-yl butyrate |
| 60 | Dimethyl Anthranilate | methyl 2-methylaminobenzoate |
| 61 | Methyl Antranilate | methyl 2-aminobenzoate |
| 62 | Octyl Aldehyde | Octanal |
| 63 | Nonanal | Nonanal |
| 64 | Decyl aldehyde | Decanal |
| 65 | Lauric Aldehyde | Dodecanal |
| 66 | Methyl Nonyl Acetaldehyde | 2-methyl undecanal |
| 67 | Methyl Octyl Acetaldehyde | 2-methyl decanal |
| 68 | 2,4 -Hexadienal | (2E,4E)-hexa-2,4-dienal |
| 69 | Intreleven Aldehyde | undec-10-enal |
| 70 | Decen-1-al | (E)-dec-2-enal |
| 71 | Nonen-1-al | (E)-2-nonen-1-al |
| 72 | Adoxal | 2,6,10-trimethylundec-9-enal |
| 73 | Geraldehyde | (4Z)-5,9-dimethyldeca-4,8-dienal |
| 74 | Iso cyclo citral | 2,4,6-trimethylcyclohex-3-ene-1- |
| | | carbaldehyde |
| 75 | d-limonene mainly | 1-methyl-4-prop-1-en-2-yl-cyclohexene |
| 76 | Ligustral | 2,4-dimethylcyclohex-3-ene-1- |
| | | carbaldehyde |
| 77 | Myrac aldehyde | 4-(4-methylpent-3-enyl)cyclohex-3-ene-1- |
| | | carbaldehyde |
| 78 | Tridecenal | tridec-2-enal |
| 79 | Triplal | 2,4-dimethyl-3-cyclohexene-1- |
| | | carboxaldehyde |
| 80 | Vertoliff | 1,2-dimethylcyclohex-3-ene-1- |
| | | carbaldehyde |
| 81 | Cyclal C | 2,4-dimethylcyclohex-3-ene-1- |
| | | carbaldehyde |
| 82 | Anisic aldehyde | 4-methoxybenzaldehyde |
| 83 | Helional | 3-(1,3-benzodioxol-5-yl)-2- |
| | | methylpropanal |
| 84 | Heliotropin | 1,3-benzodioxole-5-carbaldehyde |
| 85 | Neocaspirene | |
| 86 | Beta Naphthol Ethyl Ether | 2-ethoxynaphtalene |
| 87 | Beta Naphthol Methyl Ether | 2-methoxynaphtalene |
| 88 | hyacinth ether | 2-cyclohexyloxyethylbenzene |
| 89 | 2-heptyl cyclopentanone (fleuramone) | 2-heptylcyclopentan-1-one |
| 90 | menthone-8-thioacetate | O-[2-[(1S)-4-methyl-2- |
| | | oxocyclohexyl]propan-2-y1] ethanethioate |
| 91 | Nectaryl | 2-[2-(4-methyl-1-cyclohex-3- |
| | | enyl)propyl]cyclopentan-1-one |
| 92 | Phenyl Naphthyl Ketone | naphthalen-2-yl-phenylmethanone |
| 93 | decen-1-yl cyclopentanone | 2-[(2E)-3,7-dimethylocta-2,6-dienyl] |
| | | cyclopentan-1-one |
| 94 | fruity cyclopentanone (veloutone) | 2,2,5-trimethyl-5-pentylcyclopentan-1-one |
| 95 | 4-methoxy-2-methyl butane thiol | 4-methoxy-2-methylbutane-2-thiol |
| | (blackcurrant mercaptan) | |
| 96 | Grapefruit Mercaptan | 2-(4-methyl-1-cyclohex-3-enyl)propane- |
| | | 2-thiol |
| 97 | Buccoxime | N-(1,5-dimethyl-8- |
| | | bicyclo[3.2.1 ]octanylidene)hydroxylamine |
| 98 | Labienoxime | 2,4,4,7-Tetramethyl-6,8-nonadiene-3-one |
| | | oxime |
| 99 | Undecavertol | (E)-4-methyldec-3-en-5-ol |
| 100 | Decanal diethyl acetal | 1,1-diethoxydecane |
| 101 | Diethyl maleate | diethyl but-2-enedioate |
| 102 | Ethyl Acetoacetate | ethyl 3-oxobutanoate |
| 103 | frutonile | 2-Methyldecanenitrile |
| 104 | Methyl dioxolan | ethyl 2-(2-methyl-1,3-dioxolan-2- |
| | | yl)acetate |
| 105 | Cetalox | 3a,6,6,9a-tetramethyl-2,4,5,5a,7,8,9,9b- |
| | | octahydro-1H-benzo[e][1]benzofuran |
| 106 | Cyclopentol | |
| 107 | Delta-damascone | (E)-1-(2,6,6-trimethyl-1-cyclohex-3- |
| | | enyl)but-2-en-1-one |
| 108 | Eucalyptol | 1,3,3-trimethyl- 2-oxabicyclo[2,2,2]octane |
| 109 | Flor acetate | |
| 110 | Ionone gamma methyl | (E)-3-methyl-4-(2,6,6-trimethyl-1- |
| | | cyclohex-2-enyl)but-3-en-2-one |
| 111 | Laevo trisandol | |
| 112 | Linalool | 3,7-dimethylocta-1,6-dien-3-ol |
| 113 | Violiff | [(4Z)-1-cyclooct-4-enyl] methyl carbonate |
| 114 | Cymal | 3-(4-propan-2-ylphenyl)butanal |
| 115 | Bourgeonal | 3-(4-tert-butylphenyl)propanal |

### Shell Material.

The shell material preferably comprises a polyacrylate polymer. The shell material can comprise from about 50 wt % to about 100 wt %, more preferably from about 70 wt % to about 100 wt %, more preferably from about 80 wt % to about 100 wt %, by weight of the shell material, of polyacrylate polymer.

The shell material can optionally further comprise polyvinyl alcohol. The shell material can comprise from about 0.5 wt % to about 40 wt %, preferably from about 0.5 wt % to about 20 wt %, preferably from about 0.5 wt % to about 10 wt %, preferably from about 0.8 wt % to about 5 wt %, by weight of the shell material, of polyvinyl alcohol.

The polyacrylate polymer of the shell material can be derived from a material that comprises one or more multifunctional acrylate moieties. Preferably the multifunctional acrylate moiety is selected from group consisting of tri-functional acrylate, tetra-functional acrylate, penta-functional acrylate, hexa-functional acrylate, hepta-functional acrylate, and mixtures thereof. The polyacrylate polymer can optionally comprise a moiety selected from the group consisting of an amine acrylate moiety, methacrylate moiety, a carboxylic acid acrylate moiety, carboxylic acid methacrylate moiety, and combinations thereof.

The polyacrylate polymer can be derived from a material that comprises one or more multifunctional acrylate and/or optionally a material that comprises one or more methacrylate moieties, wherein the ratio of material that comprises one or more multifunctional acrylate moieties to material that comprises one or more methacrylate moieties is from about 999:1 to about 6:4, more preferably from about 99:1 to about 8:1, and more preferably from about 99:1 to about 8.5:1.

Preferably the multifunctional acrylate moiety is selected from group consisting of tri-functional acrylate, tetra-functional acrylate, penta-functional acrylate, hexa-functional acrylate, hepta-functional acrylate, and mixtures thereof. The polyacrylate polymer can optionally comprise a moiety selected from the group consisting of an amine acrylate moiety, methacrylate moiety, a carboxylic acid acrylate moiety, carboxylic acid methacrylate moiety, and combinations thereof.

The polyacrylate polymer of the shell material preferably comprises a cross-linked polyacrylate polymer.

The polyvinyl alcohol of the shell material, when present, preferably has one or more of the following properties:
(a) a hydrolysis degree from about 55% to about 99%, preferably from about 75% to about 95%, preferably from about 85% to about 90%, preferably from about 87% to about 89%; and/or
(b) a viscosity of from about 40 cps to about 80 cps, preferably from about 45 cps to about 72 cps, preferably from about 45 cps to about 60 cps, preferably 45 cps to 55 cps in 4% water solution at 20° C.; and/or
(c) a degree of polymerization of from about 1500 to about 2500, preferably from about 1600 to about 2200, preferably from about 1600 to about 1900, preferably from about 1600 to about 1800; and/or
(d) a weight average molecular weight of from about 130,000 to about 204,000, preferably from about 146,000 to about 186,000, preferably from about 146,000 to about 160,000, preferably from about 146,000 to about 155,000; and/or
(e) a number average molecular weight of from about 65,000 to about 110,000, preferably from about 70,000 to about 101,000, preferably from about 70,000 to about 90,000, preferably from about 70,000 to about 80,000.

Other suitable shell materials include polyethylenes, polyamides, polystyrenes, polyisoprenes, polycarbonates, polyesters, polyureas, polyurethanes, polyolefins, polysaccharides, epoxy resins, vinyl polymers, and mixtures thereof.

Other suitable shell materials are selected from the group consisting of reaction products of one or more amines with one or more aldehydes, such as urea cross-linked with formaldehyde or gluteraldehyde, melamine cross-linked with formaldehyde; gelatin-polyphosphate coacervates optionally cross-linked with gluteraldehyde; gelatin-gum arabic coacervates; cross-linked silicone fluids; polyamine reacted with polyisocyanates; acrylate monomers polymerized via free radical polymerization, and mixtures thereof.

### Deposition Aid

Any suitable deposition aids can be used. A preferred deposition aid is chitosan.

The chitosan is a linear polysaccharide comprising randomly distributed ß-(1,4)-linked D-glucosamine (deacetylated unit) and N-acetylglucosamine (acetylated unit) and generally has the following structure:

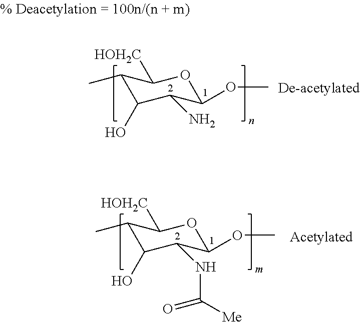

wherein n and m vary depending on the average molecular weight of the chitosan and the degree of deacetylation of the chitosan. The degree of deacetylation (% deacetylation) of the chitosan is equal to 100n/(n+m).

Suitable chitosan can have a weight average molecular weight of at least about 100 kDa (kilodaltons) and/or a degree of deacetylation of at least about 60%.

Suitable chitosan can have lower degree of deacetylation values if the chitosan has relatively higher weight average molecular weight. The chitosan may also have lower weight average molecular weight values if the chitosan has relatively higher degree of deacetylation values. Preferred chitosans have degree of deacetylation values and weight average molecular weight values that are both relatively high, which tend to exhibit lower solubility in pH buffer solution across the pH range of 2-10.

Suitable chitosan can have a degree of deacetylation of at least about 60% and a weight average molecular weight of at least about 10 kDa.

Suitable chitosan can have a weight average molecular weight of at least about 100 kDa and a degree of deacetylation of at least about 50%.

Suitable chitosan can have either:
(i) a weight average molecular weight of at least about 500 kDa and a degree of de-acetylation of at least about 50%; or
(ii) a weight average molecular weight of at least about 10 kDa and a degree of de-acetylation of at least about 70%.

Suitable chitosan can have a degree of deacetylation of at least about 60%, preferably at least about 70%, and preferably at least about 75%.

Suitable chitosan can have a weight average molecular weight of at least about 100 kDa, preferably at least about 200 kDa, and preferably at least about 400 kDa.

Typically, the amine group of chitosan has a pKₐ of about 6.5 and results in protonation of the chitosan in acidic to neutral solutions, with the charge density largely dependent upon the degree of deacetylation of the chitosan and the pH of solution. As such, the chitosan is typically cationic and can readily bind to anionically charged surfaces.

The chitosan is generally disposed on the outer surface of the salted perfume microcapsule particle.

Other deposition aids may comprise a polymer selected from the group comprising: polysaccharides, cationically modified starch, and/or cationically modified guar; polysiloxanes; poly diallyl dimethyl ammonium halides; copolymers of poly diallyl dimethyl ammonium chloride and polyvinyl pyrrolidone; a composition comprising polyethylene glycol and polyvinyl pyrrolidone; acrylamides; imidazoles; imidazolinium halides; polyvinyl amine; copolymers of poly vinyl amine and N-vinyl formamide; polyvinyl formamide, polyvinyl alcohol; polyvinyl alcohol crosslinked with boric acid; polyacrylic acid; polyglycerol ether silicone cross-polymers; polyacrylic acids, polyacrylates, copolymers of polyvinylamine and polvyinylalcohol oligomers of amines, in one aspect a diethylenetriamine, ethylene diamine, bis(3-aminopropyl)piperazine, N,N-Bis-(3-aminopropyl)methylamine, tris(2-aminoethyl)amine and mixtures thereof; polyethyleneimine, a derivatized polyethyleneimine, in one aspect an ethoxylated polyethyleneimine; a polymeric compound comprising, at least two moieties selected from the moieties consisting of a carboxylic acid moiety, an amine moiety, a hydroxyl moiety, and a nitrile moiety on a backbone of polybutadiene, polyisoprene, polybutadiene/styrene, polybutadiene/acrylonitrile, carboxyl-terminated polybutadiene/acrylonitrile or combinations thereof; pre-formed coacervates of anionic surfactants combined with cationic polymers; polyamines and mixtures thereof.

### Structurant/Rheology Modifier.

The compositions of the present disclosure may contain a rheology modifier and/or a structurant. Rheology modifiers may be used to “thicken” or “thin” liquid compositions to a desired viscosity. Structurants may be used to facilitate phase stability and/or to suspend or inhibit aggregation of particles in liquid composition, such as the delivery particles as described herein.

Suitable rheology modifiers and/or structurants may include non-polymeric crystalline hydroxyl functional structurants (including those based on hydrogenated castor oil), polymeric structuring agents, cellulosic fibers (for example, microfibrillated cellulose, which may be derived from a bacterial, fungal, or plant origin, including from wood), di-amido gellants, or combinations thereof. A preferred structurant is microfibrilated cellulose, preferably of plant origin.

Polymeric structuring agents may be naturally derived or synthetic in origin. Naturally derived polymeric structurants may comprise hydroxyethyl cellulose, hydrophobically modified hydroxyethyl cellulose, carboxymethyl cellulose, polysaccharide derivatives and mixtures thereof. Polysaccharide derivatives may comprise pectine, alginate, arabinogalactan (gum Arabic), carrageenan, gellan gum, xanthan gum, guar gum and mixtures thereof. Synthetic polymeric structurants may comprise polycarboxylates, polyacrylates, hydrophobically modified ethoxylated urethanes, hydrophobically modified non-ionic polyols and mixtures thereof. Polycarboxylate polymers may comprise a polyacrylate, polymethacrylate or mixtures thereof. Polyacrylates may comprise a copolymer of unsaturated mono- or di-carbonic acid and C₁-C₃₀ alkyl ester of the (meth)acrylic acid. Such copolymers are available from Noveon inc under the tradename Carbopol Aqua 30. Cross-linked polymers, such as cross-linked polyacrylate and/or polymers and/or co-polymers, such as those that further include nonionic monomers such as acrylamide or methacrylamide monomers, may be useful as structurants. Another suitable structurant is sold under the tradename Rheovis CDE, available from BASF.

Preferred structurant is microfibrilated cellulose.

### Partitioning Modifier

Suitable partitioning modifiers are selected from the group consisting of vegetable oil, modified vegetable oil, isopropyl myristate, propan-2-yl tetradecanoate, and mixtures thereof. Suitable vegetable oils are selected from the group consisting of castor oil, soybean oil, and mixtures thereof. Suitable modified vegetable oils are selected from the group consisting of esterified vegetable oil, brominated vegetable oil, and mixtures thereof. Preferred partitioning modifiers are selected from isopropyl myristate, propan-2-yl tetradecanoate, and mixtures thereof.

### Emulsifier

Optionally, the water phase may include an emulsifier. Non-limiting examples of emulsifiers include anionic surfactants (such as alkyl sulfates, alkyl ether sulfates, and/or alkyl benzenesulfonates), nonionic surfactants (such as alkoxylated alcohols, preferably comprising ethoxy groups), polyvinyl alcohol, and/or polyvinyl pyrrolidone. It may be that solubilized chitosan can provide emulsifying benefits in the present applications.

Emulsifier, if employed, is typically from about 0.1 to 40% by weight, preferably 0.2 to about 15% by weight, more typically 0.5 to 10% be weight, based on total weight of the aqueous phase.

### Initiator

The (meth)acrylate polymer of the polymer wall may be further derived, at least in part, from at least one free radical initiator, preferably at least two free radical initiators. The at least one free radical initiator may preferably comprise a water-soluble or water-dispersible free radical initiator. One or more free radical initiators can provide a source of free radicals upon activation.

The amount of initiator present may be from about 2% to about 50%, preferably from about 5% to about 40%, more preferably from about 10% to about 40%, even more preferably from about 15% to about 40%, even more preferably from about 20% to about 35%, 30 or more preferably from about 20% to about 30%, by weight of the polymer wall. The (meth)acrylate polymer of the polymer wall may be derived from a first initiator and a second initiator, wherein the first and second initiators are present in a weight ratio of from about 5:1 to about 1:5, or preferably from about 3:1 to about 1:3, or more preferably from about 2:1 to about 1:2, or even more preferably from about 1.5:1 to about 1:1.5.

Suitable free radical initiators may include peroxy initiators, azo initiators, peroxides, and compounds such as 2,2′-azobismethylbutyronitrile, dibenzoyl peroxide. More particularly, and without limitation, the free radical initiator can be selected from the group of initiators comprising an azo or peroxy initiator, such as peroxide, dialkyl peroxide, alkylperoxide, peroxyester, peroxycarbonate, peroxyketone and peroxydicarbonate, 2,2′-azobis (isobutylnitrile), 2,2′-azobis(2,4-dimethylpentanenitrile), 2,2′-azobis (2,4-dimethylvaleronitrile), 2,2′-azobis(2-methylpropanenitrile), 2,2′-azobis(2-methylbutyronitrile), 1,l′-azobis (cyclohexanecarbonitrile), 15 1,1′-azobis(cyanocyclohexane), benzoyl peroxide, decanoyl peroxide; lauroyl peroxide; benzoyl peroxide, di(n-propyl)peroxydicarbonate, di(sec-butyl) peroxydicarbonate, di(2-ethylhexyl)peroxydicarbonate, 1,1-dimethyl-3-hydroxybutyl peroxyneodecanoate, a-cumyl peroxyncoheptanoate, t-amyl peroxyncodecanoate, t-butyl peroxyneodecanoate, t-amyl peroxypivalate, t-butyl peroxypivalate, 2,5-dimethyl 2,5-di (2-ethylhexanoyl peroxy)hexane, t20 amyl peroxy-2-ethyl-hexanoate, t-butyl peroxy-2-ethylhexanoate, t-butyl peroxyacetate, di-tamyl peroxyacetate, t-butyl peroxide, dit-amyl peroxide, 2,5-dimethyl-2,5-di-(tbutylperoxy) hexyne-3, cumene hydroperoxide, 1,1-di-(t-butylperoxy)-3,3,5-trimethylcyclohexane, 1,1-di-(t-butylperoxy)-cyclohexane, 1,1-di-(t-amylperoxy)-cyclohexane, ethyl-3,3-di-(t-butylperoxy)-butyrate, t-amyl perbenzoate, t-butyl perbenzoate, ethyl 3,3-di-(t-amylperoxy)-butyrate, and the like.

### Method of Measuring the Powder to Volume Ratio of a Mixer

The power to volume ratio is typically determined by direct measurement of the electrical power supplied to the mixer motor divided by the volume of the aqueous mixture in the tank multiplied by the motor efficiency.

$$\frac{P}{V} = \frac{Electrical power input}{Aqueous mixture volume} \cdot motor efficiency \qquad ( 1 )$$

### Method of Measuring Solubility

The water solubility of a substance is the saturation mass concentration of the substance in water at a given temperature. Water solubility is expressed in mass of solute per volume of solution, kg/m3 and/or g/100 ml.

In a stepwise procedure, increasing amounts of the salt (approximately 1 g) are added to 100 ml of de-ionised water at 20+0.5° C. After each addition of salt sample, the mixture is shaken for 10 minutes, and the pH is measured. This process is repeated until the pH is not alter by more than 0.001% vs previous measurement.

### Embodiments of the Present Invention

1. A process of making a salted spray-dried perfume microcapsule particle, wherein the process comprises the steps:
   (a) preparing an aqueous perfume microcapsule mixture comprising from 20 wt % to 70 wt % perfume microcapsules;
   (b) contacting sodium chloride to the aqueous perfume microcapsule mixture to form a salted aqueous perfume microcapsule mixture comprising from 2.0 wt % to 10 wt % said sodium chloride; and
   (c) spray-drying the salted aqueous perfume microcapsule mixture to form a salted spray-dried perfume microcapsule particle, wherein the salted spray-dried perfume microcapsule particle comprises from 4.0 wt % to 20 wt % said sodium chloride.
2. A process according to any preceding claim, wherein said aqueous perfume microcapsule mixture comprises from 30 wt % to 60 wt % perfume microcapsules.
3. A process according to any preceding claim, wherein said salted aqueous perfume microcapsule mixture comprises from 2.0 wt % to 5.0 wt % said sodium chloride.
4. A process according to any preceding claim, wherein said salted spray-dried perfume microcapsule particle comprises from 5.0 wt % to 20 wt % said sodium chloride.
5. A process according to any preceding claim, wherein said aqueous perfume microcapsule mixture comprises 30 wt % to 80 wt % water.
6. A process according to any preceding claim, wherein step (b) is carried out in a mixer having a tip speed of from 5.0 ms⁻¹ to 50 ms⁻¹.
7. A process according to any preceding claim, wherein step (b) is carried out in a mixer having a powder to volume ratio of from 2 kWm⁻³ to 20 kWm⁻³.
8. A process according to any preceding claim, wherein step (b) is carried out in a mixer, and wherein said sodium chloride and said aqueous perfume microcapsule mixture are mixed together for at least five minutes to form said salted aqueous perfume microcapsule mixture.
9. A process according to any preceding claim, wherein step (c) is carried out in a spray-drying tower having an air inlet temperature of from 140° C. to 220° C.
10. A process according to any preceding claim, wherein step (c) is carried out in a spray-drying tower, and wherein said salted aqueous perfume microcapsule mixture is sprayed into said spray-drying tower by a means selected from:
   (a) a spinning wheel nozzle being operated at a rotation of at least 10,000 rpm; and/or
   (b) a high-pressure nozzle being operated at an atomizer pressure of at least 3.5×10⁶ Pa.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### EXAMPLES

Three liters of two slurry formulations A and B were prepared based on compositions given in Table 1 (percentage by weight). The slurry with perfume microcapsules was mixed with anhydrous silica using an impeller bench-top mixer for 15 min (example A). The same mixing conditions and time were used to fully dissolve NaCl in the example B.

The mixture was sprayed dried in a spray-drying tower with a spinning wheel atomizer rotating at 16000 rpm. The inlet air temperature was kept at 190° C. and the fluid flow was controlled to be within a 8-10 liters/min range. The resultant spray-dried particle compositions are given in Table 2.

The resultant powder samples were assessed for the standard UN Test N.1—Combustible Solids, compromising on Screening Test (ST) and Burning Rate Test (BR). The result of ST corresponds to the propagation time for a length of 200 mm of the dried powder (mold 250 mm×10 mm×20 mm) after being approach by an ignition source. The BR test evaluates the propagation time for a length of 100 mm of the powder pile using identical mold after pouring 1 ml of a wetting solution.

TABLE 1
Slurry Compositions

| Materials | A | B |
|---|---|---|
| Perfume oil | 25.9 | 25.5 |
| Perfume microcapsule | 16.8 | 16.6 |
| Sodium Chloride (NaCl) | 0 | 2.3 |
| Anhydrous silica | 1.3 | 1.3 |
| Water | 56 | 54.3 |

TABLE 2
Powder Compositions

| Materials | A | B |
|---|---|---|
| Perfume oil | 57.9 | 55.1 |
| Perfume microcapsules | 37.6 | 35.4 |
| Sodium Chloride (NaCl) | 0 | 5 |
| Anhydrous silica | 3 | 3 |
| Water | 1.5 | 1.5 |

TABLE 3
Flammability results

| | ST, s 200 mm | BR, s |
|---|---|---|
| | (<120 s | <45s Class 4 |
| Example | flammable solid) | combustible solid) |
| A | 80 | 33 |
| B | 182 | N/A |

What is claimed is:

1. A process of making a salted spray-dried perfume microcapsule particle, wherein the process comprises the steps:
(a) preparing an aqueous perfume microcapsule mixture comprising from about 20 wt % to about 70 wt % perfume microcapsules;
(b) contacting sodium chloride to the aqueous perfume microcapsule mixture to form a salted aqueous perfume microcapsule mixture comprising from about 2.0 wt % to about 10 wt % said sodium chloride; and
(c) spray-drying the salted aqueous perfume microcapsule mixture to form a salted spray-dried perfume microcapsule particle, wherein the salted spray-dried perfume microcapsule particle comprises from about 4.0 wt % to about 20 wt % said sodium chloride.

2. A process according to claim 1, wherein said aqueous perfume microcapsule mixture comprises from about 30 wt % to about 60 wt % perfume microcapsules.

3. A process according to claim 1, wherein said salted aqueous perfume microcapsule mixture comprises from about 2.0 wt % to about 5.0 wt % said sodium chloride.

4. A process according to claim 3, wherein said salted spray-dried perfume microcapsule particle comprises from about 5.0 wt % to about 20 wt % said sodium chloride.

5. A process according to claim 1, wherein said aqueous perfume microcapsule mixture comprises about 30 wt % to about 80 wt % water.

6. A process according to claim 1, wherein step (b) is carried out in a mixer having a tip speed of from about 5.0 ms⁻¹ to about 50 ms⁻¹.

7. A process according to claim 6, wherein step (b) is carried out in a mixer having a powder to volume ratio of from about 2 kWm⁻³ to about 20 kWm⁻³.

8. A process according to claim 1, wherein step (b) is carried out in a mixer, and wherein said sodium chloride and said aqueous perfume microcapsule mixture are mixed together for at least five minutes to form said salted aqueous perfume microcapsule mixture.

9. A process according to claim 1, wherein step (c) is carried out in a spray-drying tower having an air inlet temperature of from about 140° C. to about 220° C.

10. A process according to claim 1, wherein step (c) is carried out in a spray-drying tower, and wherein said salted aqueous perfume microcapsule mixture is sprayed into said spray-drying tower by a means selected from:
(a) a spinning wheel nozzle being operated at a rotation of at least about 10,000 rpm; and/or
(b) a high-pressure nozzle being operated at an atomizer pressure of at least about 3.5×10⁶ Pa.
